(19) United States
(12) Patent Application Publication
(10) Pub. No.: US 2011/0246827 A1
(43) Pub. Date: Oct. 6, 2011

(54) Testing Device and Testing Method

(76) Inventor: Ching-An Lin, Taipei Hsien (TW)

(21) Appl. No.: 12/889,411

(22) Filed: Sep. 24, 2010

(30) Foreign Application Priority Data
Mar. 31, 2010 (TW) 099109895

(51) Int. Cl. G06F 11/26

(52) U.S. Cl. 714/27; 714/E11.159

(57) ABSTRACT

A testing device for testing an embedded system includes an interface capable of being coupled to the embedded system by means of insertion, a storage unit for storing data, and a processor for receiving a testing message corresponding to a testing command from the embedded system via the interface according to an enabling signal and storing the testing message into the storage unit when the interface is coupled to the embedded system.

### BACKGROUND OF THE INVENTION

1. Field of the Invention

The present invention relates to a testing device and testing method, and more particularly, to a testing device and testing method for testing an embedded system and capable of reducing required manpower and time.

2. Description of the Prior Art

Electronic products have to undergo a series of quality or reliability tests before leaving manufactories, to avoid defective products from entering the market and to ensure competitiveness of the products. Generally, to enhance testing efficiency, a manufacturer performs a testing procedure for several devices simultaneously. The testing procedure is to command the devices to execute specific functions (or operations), and check whether the specific functions are correctly completed or testing results are correct. If one of the devices fails in the testing procedure, meaning that defectiveness of the device is detected, the manufacturer has to record question points for further improvements. Under such a situation, testing operators perform the same test on the failed devices, and grab important information via specific fixtures, in order to determine the question points. However, performing the same test may not generate the same testing results, such that manpower and time for further debugging are required, causing testing and manufacturing efficiency decreased.

Therefore, there is a need for improving testing methods of electronic products.

### SUMMARY OF THE INVENTION

It is therefore an objective of the claimed invention to provide a testing device and a testing method.

The present invention discloses a testing device for testing an embedded system includes an interface capable of being coupled to the embedded system by means of insertion, a storage unit for storing data, and a processor for receiving a testing message corresponding to a testing command from the embedded system via the interface according to an enabling signal and storing the testing message into the storage unit.

The present invention further discloses a test method for testing an embedded system includes transmitting a testing message corresponding to a testing command from the embedded system to a testing device according to an enabling signal, to store the testing message into the testing device, when the testing device is coupled to the embedded system.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of a testing device according to an embodiment of the present invention.

FIG. 2 is a schematic diagram of a testing process according to an embodiment of the present invention.

FIG. 3 is an operational diagram of storing data from a storage unit shown in FIG. 1.

FIG. 4 is a schematic diagram of a modified embodiment according to the testing device of FIG. 1.

### DETAILED DESCRIPTION

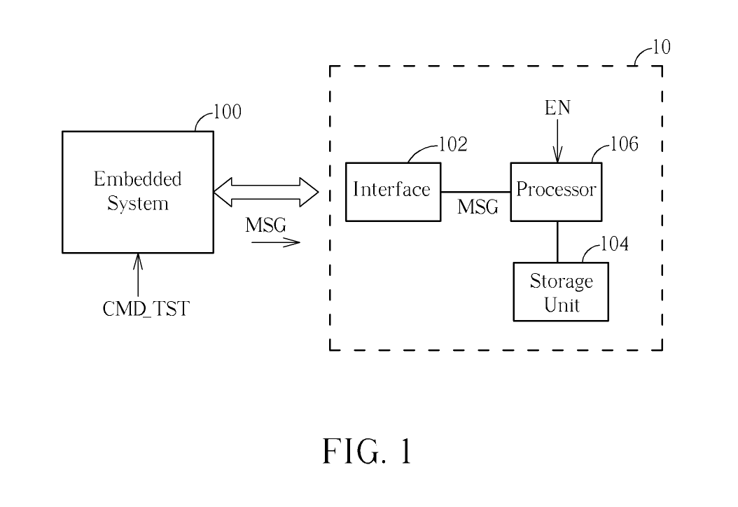

Please refer to FIG. 1, which is a schematic diagram of a testing device 10 according to an embodiment of the present invention. The testing device 10 is utilized for testing an embedded system 100, and includes an interface 102, a storage unit 104, and a processor 106. The embedded system 100 can be a computer system, mobile phone, recreation device, audio and video equipment, digital camcorder, information appliance, advanced medical equipment, and so on. The interface 102 is utilized for being coupled to the embedded system 100 by means of insertion, and can be a common signal transmission terminal, such as a universal serial bus (USB) port, a VGA port, an IEEE1394 port, etc., or a dedicated connector for the embedded system 100. When the interface 102 is coupled to the embedded system 100, the processor 106 is triggered by an enabling signal EN to receive a testing message MSG corresponding to a testing command CMD TST from the embedded system 100 via the interface 102, and store the testing message MSG into the storage unit 104.

In short, when testing the embedded system 100, as long as a testing operator connects the testing device 10 to the embedded system 100 and properly sets the enabling signal EN, the testing message MSG generated by the embedded system 100 would be automatically stored into the testing device 10. Thus, even if the embedded system 100 is defective and fails in a test, the testing operator can grab relative information via the testing device 10 without performing the same test again. Hence, manpower and time required for performing tests can be significantly reduced, defect or problem points can be preciously determined, and thus testing and manufacturing efficiencies can be effectively improved.

Note that, the testing device 10 shown in FIG. 1 is to illustrate the concept of the present invention, and those skilled in the art can make modifications accordingly. For example, the enabling signal EN is utilized for indicating the processor 106 whether to trigger the function of storing the testing message MSG, and can be generated by a switch or a switching machine. In addition, according to system requirements, the enabling signal EN can further indicate the processor 106 whether to trigger a function of reading the testing message MSG. That is, the testing device 10 can be operated in two modes. When the enabling signal is 1 (or a specific value), the processor 106 stores the testing message MSG received from the interface 102 into the storage unit 104. When the enabling signal is 0 (or another specific value), the processor 106 outputs the data stored in the storage unit 104 via the interface 102. In other words, when the enabling signal is 1, the testing device 10 is utilized for automatically storing the testing message MSG, and when the enabling signal is 0, the testing device 10 is utilized for outputting the stored data like a memory card. Thus, through switching the enabling signal EN, the testing operator can timely record the testing message MSG, or obtain the testing message MSG stored in the testing device 10 via a computer or other devices after finishing the testing procedure.

Moreover, to ensure that the testing message MSG can be correctly stored, when the interface 102 is coupled to the embedded system 100, if the enabling signal EN indicates to execute the function of storing the testing message MSG (e.g. EN=1), the processor 106 can initialize and establish a communication connection with the embedded system 100 via the interface 102.

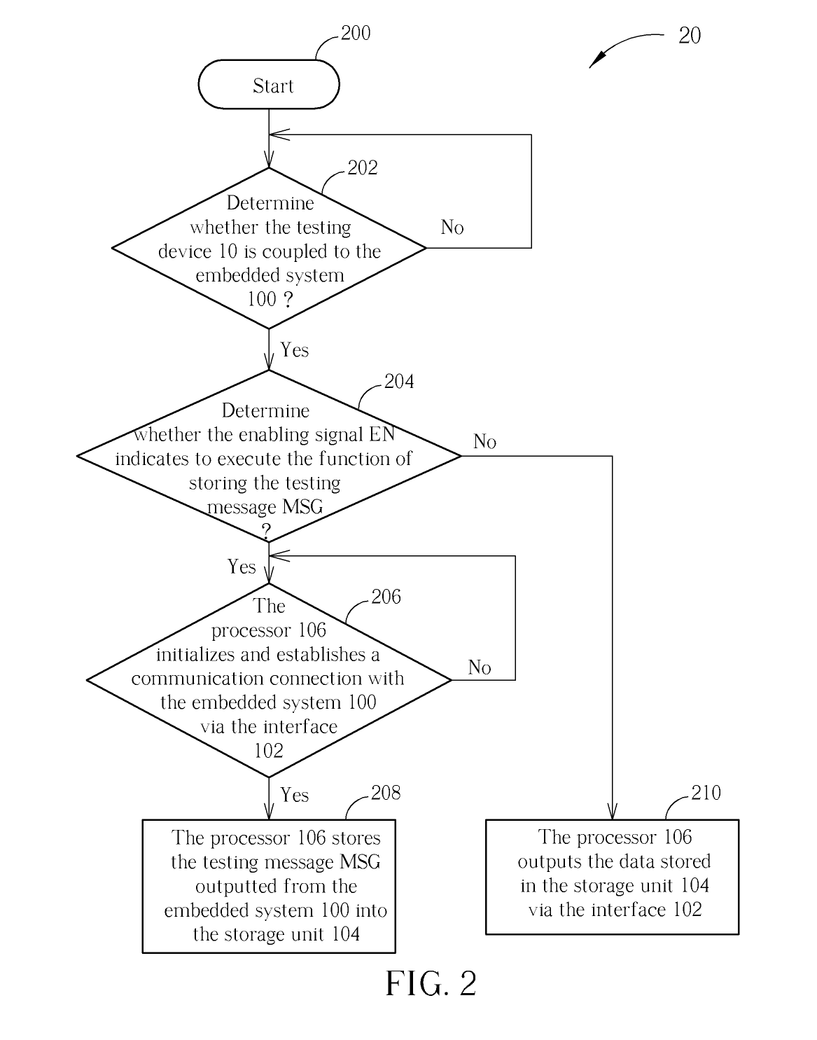

The operations described in the above can be concluded into a testing process 20, as shown in FIG. 2. The testing process 20 includes the following steps:

Step 200: Start.

Step 202: Determine whether the testing device 10 is coupled to the embedded system 100. If true, proceed to step 204; else, repeat step 202.

Step 204: Determine whether the enabling signal EN indicates to execute the function of storing the testing message MSG. If true, proceed to step 206; else, proceed to step 210.

Step 206: The processor 106 initializes and establishes a communication connection with the embedded system 100 via the interface 102.

Step 208: The processor 106 stores the testing message MSG outputted from the embedded system 100 into the storage unit 104.

Step 210: The processor 106 outputs the data stored in the storage unit 104 via the interface 102.

As shown in the testing process 20, the testing device 10 not only stores the testing message MSG, but also outputs the stored data like a memory card or storage device. As a result, after finishing the testing procedure, the testing operator can obtain the stored data of the testing device 10 by coupling the testing device 10 to a computer system or a testing result analyzer and adjusting the enabling signal EN. Under such a situation, if the embedded system 100 fails in the testing procedure or is hanged up, the testing operators can grab the relative information without performing the same test again.

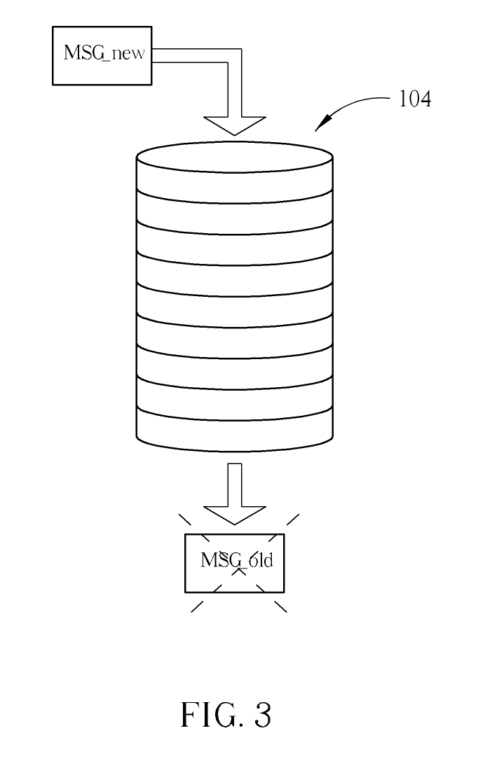

Hardware architecture or operational process of the testing device 10 described in the above illustrates the spirit of the present invention, and those skilled in the art can make proper modifications according to system requirements. For example, operations of the processor 106 storing the testing message MSG into the storage unit 104 can be modified according to a storing space of the storage unit 104 or requirements of the testing operator. When the storing space of the storage unit 104 is insufficient, the processor 106 can overwrite the testing message MSG into the storage unit 104, i.e. delete old data (the stored message) and store new data. In addition, when the storing space of the storage unit 104 is sufficient for more than one testing message MSG, the processor 106 keeps storing the testing message MSG, and when the storage unit 104 is full, the processor 106 deletes the oldest data to store the latest data, as shown in FIG. 3. In FIG. 3, MSG new denotes a latest testing message outputted from the processor 106 to the storage unit 104, and MSG old denotes an oldest testing message stored in the storage unit 104. As shown in FIG. 3, when the storage unit 104 is full, the oldest testing message MSG old is deleted, in order to store the latest message MSG new. Preferably, the processor 106 generates the new testing message MSG and stores the testing message MSG into the storage unit 104 once the testing device 10 is coupled to the embedded system 100.

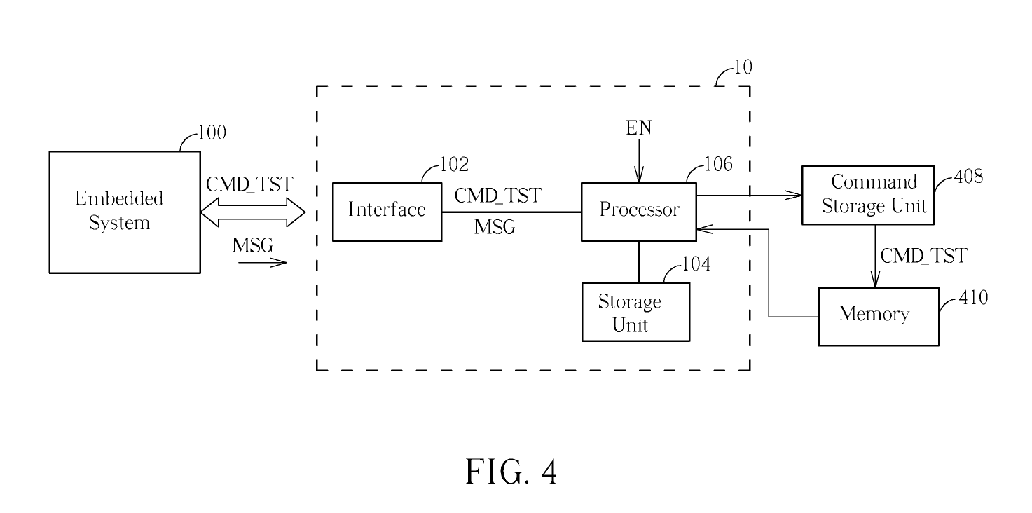

Moreover, in FIG. 1, the testing command CMD_TST is utilized for controlling the embedded system 100 to execute specific functions or operations, and can be provided by an external device or pre-stored in the testing device 10. For example, if the testing command CMD_TST is pre-stored in the testing device 10, as shown in FIG. 4, a command storage unit 408 and a memory 410 are added into the testing device 10. The command storage unit 408 is utilized for storing the testing command CMD_TST, while the memory 410 is utilized for temporarily storing the testing command CMD_TST. After the testing device 10 establishes the communication connection with the embedded system 100, the processor 106 obtains the testing command CMD_TST from the storage unit 408, transmits the testing command CMD_TST to the memory 410, transforms the testing command CMD_TST into a format that the embedded system 100 recognizes, transmits the transformed testing command CMD_TST to the embedded system 100 via the interface 102, and then starts to record the testing message MSG. In such a way, the testing operator can perform the testing procedure via coupling the testing device 10 to the embedded system 100. Certainly, more than one testing command can be pre-stored in the command storage unit 408, and then the testing operator selects a required testing command to be executed.

In the prior art, the testing operator performs the same test on the failed devices, and grabs the important information via specific fixtures during the test, so as to confirm the defective points. However, when the testing operator restarts the same test, the testing results may not be the same, such that the manufacturer has to waste much manpower and time on debugging, and testing and manufacturing efficiencies are degraded. In comparison, in the present invention, the testing operator only connects the testing device 10 to the embedded system 100 and properly sets the enabling signal EN, and then, the testing message MSG generated from the embedded system 100 is automatically stored into the testing device 10. As a result, when the embedded system 100 is defective and fails in the testing procedure, the testing operator can grab the relative information via the testing device 10 without performing the same test. Hence, testing manpower and time can be significantly decreased, the problem points can be preciously controlled, so as to enhance testing and manufacturing efficiencies.

To sum up, the present invention can significantly reduce testing manpower and time, so as to effectively enhance testing and manufacturing efficiencies.

Those skilled in the art will readily observe that numerous modifications and alterations of the device and method may be made while retaining the teachings of the invention.

What is claimed is:

1. A testing device for testing an embedded system, comprising:
an interface, capable of being coupled to the embedded system by means of insertion;
a storage unit, for storing data; and
a processor, for obtaining a testing message corresponding to a testing command from the embedded system via the interface according to an enabling signal and storing the testing message into the storage unit when the interface is coupled to the embedded system.

2. The testing device of claim 1, wherein the interface conforms to a standard of a universal serial bus.

3. The testing device of claim 1, further comprising a switch for generating the enabling signal.

4. The testing device of claim 1, wherein the processor is further utilized for establishing a communication connection with the embedded system via the interface according to the enabling signal when the interface is coupled to the embedded system.

5. The testing device of claim 1, wherein the processor is further utilized for deleting a message stored in the storage unit when a storing space of the storage unit is insufficient, so as to store the testing message into the storage unit.

6. The testing device of claim 1, further comprising a command storage unit for storing the testing command, wherein the processor is further utilized for outputting the testing command to the embedded system via the interface according to the enabling signal.

7. The testing device of claim 1, further comprising a memory for temporarily storing the testing command.

8. The testing device of claim 1, wherein the processor is further utilized for outputting the data stored in the storage unit to the embedded system via the interface according to the enabling signal when the interface is coupled to the embedded system.

9. The testing device of claim 1, wherein the embedded system is a computer system.

10. A testing method for testing an embedded system, comprising:
when a testing device is coupled to the embedded system, transmitting a testing message corresponding to a testing command from the embedded system to the testing device according to an enabling signal, to store the testing message into the testing device.

11. The testing method of claim 10, wherein when the testing device is coupled to the embedded system, the method further comprises establishing a communication connection between the testing device and the embedded system according to the enabling signal.

12. The testing method of claim 10, wherein when a storing space of the testing device is insufficient, the method further comprises deleting a message stored in the testing device, so as to store the testing message into the testing device.

13. The testing method of claim 10, further comprising the testing device storing the testing command and outputting the testing command to the embedded system.

14. The testing method of claim 10, further comprising outputting data stored by the testing device to the embedded system according to the enabling signal when the testing device is coupled to the embedded system.

15. The testing method of claim 10, wherein the embedded system is a computer system.
